(19) United States
(12) Patent Application Publication
(10) Pub. No.: US 2011/0310712 A1
(43) Pub. Date: Dec. 22, 2011

(54) TIMEPIECE

(75) Inventors: Alberto Papi, La Chaux-de-Fonds (CH); Pedro Nunes Marques, Le Locle (CH)

(73) Assignees: SOWIND S.A., La Chaux-de-Fonds (CH); VAUCHER MANUFACTURE FLEURIER S.A., Fleurier (CH)

(21) Appl. No.: 13/203,850

(22) PCT Filed: Mar. 2, 2010
(86) PCT No.: PCT/EP2010/052639

§ 371 Date: Aug. 30, 2011

(30) Foreign Application Priority Data
Mar. 5, 2009 (EP) 09154446.0

(51) Int. Cl. G04B 29/04; G04B 21/02; G04B 21/00

(52) U.S. Cl. 368/269; 368/319; 368/243

(57) ABSTRACT

A timepiece, including: a power source; a control member (32) movable between a first and second position defined by a power reserve mechanism; an additional mechanism; a triggering nose (16), the movement of which triggers the additional mechanism; and a triggering member (10) to be actuated for interaction with the triggering nose (6) for triggering the additional mechanism. The triggering member is capable of assuming a first position in which it engages with the triggering nose (16), and a second position in which it cannot engage with the triggering nose (16). The control member (32) is arranged so as to engage with the triggering member (10) and to move into the first or second position depending on whether the control member (32) is in the first or second position.

### TECHNICAL FIELD

The present invention relates to a timepiece, comprising:
an energy source,
a control organ able to move between first and second positions defined by a power reserve mechanism,
an additional mechanism,
a release beak whereof the movement can cause the release of the additional mechanism, and
a release organ intended to receive pressure from a user of the timepiece to cooperate with said release beak to release the additional mechanism.

The operation of such a timepiece provided with an additional mechanism is thus secured, particularly for the case where the energy source is used both to power the additional mechanism and to power the going train of the movement. In fact, when the energy source reaches a predefined power reserve, from which it is preferable for the remaining energy to serve only to power the going train, the additional mechanism can no longer be actuated. Such a timepiece is particularly interestingly applicable in the case where the additional mechanism is a striking mechanism. In fact, during its operation, a striking mechanism consumes considerable energy, which can be to the detriment of the going train.

### BACKGROUND OF THE INVENTION

Striking mechanisms make it possible to indicate, upon request, the time to within the minute, using blows struck by two hammers on two different gongs, are well known by those skilled in the art. They can also make it possible to strike automatically of the hours and quarters. The hammers are actuated by lifts that are raised by a striking mechanism. The latter comprises an hour piece, a quarter piece and a minute piece, respectively provided with twelve, three and fourteen teeth to strike the hours, quarters and minutes.

In the striking mechanisms of the state of the art, so as to adjust the movement of said pieces, an hour cam is arranged on a star with twelve teeth, advancing by one pitch per hour, while a quarter cam and a minute cam can be adjusted on a pivot shank. Three levers, each provided with a sampler cooperating with said cams, make it possible to determine the travel of the hour, quarter and minute pieces and to adjust the number of blows struck.

Other details on this type of complication can be found, in particular on the driving force of the repeater or on the release step, i.e. on the release of the striking mechanism, in the book “Théorie de l'horlogerie” by Reymondin et al, Fédération des Ecoles Techniques, 1998, ISBN 2-940025-10-X, pages 219 to 224.

Document EP1760545 proposes a timepiece as proposed above, in which the additional mechanism is a striking mechanism. More particularly, the release of a striking mechanism requires the disengagement of the engaging lever so as to unlock the striking racks and allow the latter to take their information on their respective cam. A locking system is also provided so as to prevent the engaging lever from disengaging, when the power reserve of the barrel is below a predefined value. The proposed solution is adapted to a movement in which the energy source is remote from the release organ. However, aside from its complexity, it also has the drawback of being exclusively applicable to the striking mechanism as described in this document.

The present invention aims to propose a particularly reliable security system that can be applied to other striking mechanisms, and more generally to other additional mechanisms.

### BRIEF DESCRIPTION OF THE INVENTION

More precisely, the invention relates to a timepiece as mentioned in the first paragraph above, in which the release organ can occupy a first position in which it can cooperate with the beak and a second position in which it cannot cooperate with the beak. Moreover, the control organ is arranged so as to cooperate with the release organ and to bring it into its first or second positions, depending on whether said control organ is in its first or second position.

According to one advantageous embodiment, the control organ includes a lever and a cam driven by the barrel, said lever being able to occupy either a first or second position.

Said cam can be a finger mounted on a wheel pivoting over less than 360° between maximum winding and maximum unwinding of the barrel.

Moreover, the lever can include a catch with which the cam cooperates to make the lever go from one to the other of the first and second positions.

According to one preferred embodiment, the release organ includes a lever actuated by a push-piece, ending with a hinged portion intended to cooperate with the control organ.

The control organ can also include a protruding element cooperating with a hollow formed in the hinged portion.

Guide elements can also be arranged so as to cooperate with the release organ.

### BRIEF DESCRIPTION OF THE DRAWINGS

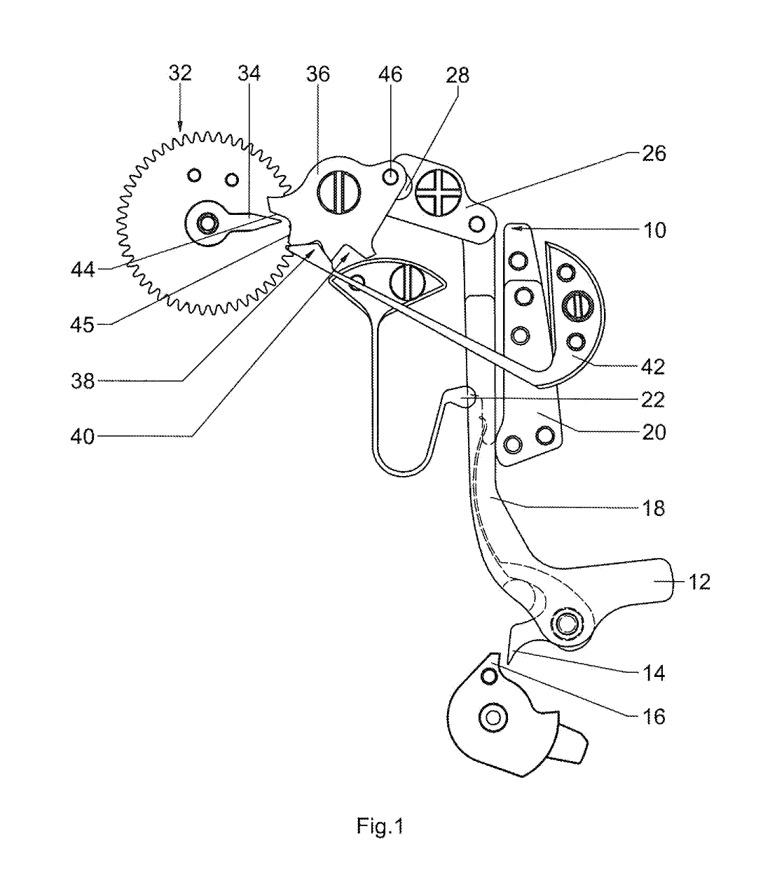

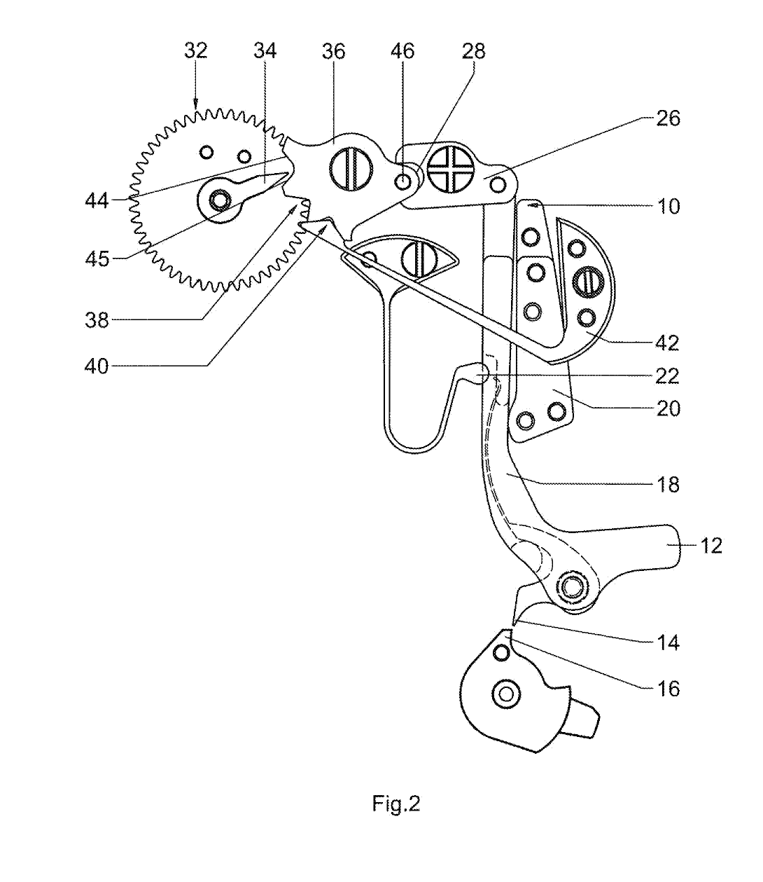

Other features of the present invention will appear more clearly upon reading the following description, done in reference to the appended drawing, in which FIGS. 1 and 2 show the mechanism according to the invention, in its first and second positions, respectively.

### DETAILED DESCRIPTION OF THE INVENTION

The drawing shows the elements that are essential to understand the invention, of a striking mechanism of a timepiece movement. These elements are shown on bridges or plates of the movement, without this needing to be specified later. The striking mechanism comprises an energy source, typically a barrel, to power it. This barrel can also be used to power a going train with which the movement is provided to display the current time.

To release a striking mechanism on request, the mechanism includes a release organ 10. According to one preferred embodiment, the release organ 10 ends with a push-piece that can be actuated from outside the movement, on which a user exerts pressure to cause striking. This push-piece 12 is slidingly mounted on the periphery of the movement, in an essentially radial direction.

The push-piece 12 drives, in its movements, a finger 14 arranged to actuate the striking mechanism. In the proposed example, the finger 14 is able to cooperate with a release beak 16 whereof the movement will drive the beginning of the set of actions that follow each other during the progression of a striking.

The push-piece 12 is extended by a lever 18 whereof the end opposite the push-piece is advantageously situated, as will be understood hereafter, near the barrel of the striking mechanism. For guiding thereof, the lever 18 is kept bearing against a bridge 20 by a spring 22. Advantageously, the spring 22 also allows the push-piece to return to its rest position after the user has actuated it. It can be considered that, in one embodiment of the push-piece 12 not shown, the finger 14 and the lever 18 are made in a single piece. In FIGS. 1 and 2, the finger 14 is mounted freely pivoting on the push-piece 12. A spring keeps the finger 14 bearing against a stop, arranged on the push-piece 12. This stop then makes it possible, during actuation of the push-piece by a user, for the finger 14 to be driven together with the push-piece 12 when it cooperates with the beak 16. Such an arrangement makes it possible that, if the user keeps the push-piece in a pushed position during striking and the finger 14 goes to the other side of the beak 16, the push-piece 12 can return to its initial position, without locking on the beak 16, owing to the fact that the finger 14 can retract in that direction. The spring guarantees the return of the finger 14 to its initial position.

The end of the lever 18 opposite the push-piece ends with a hinged portion 26. More particularly, the portion 26 pivots freely at the end of the lever. It includes a hollow 28 formed at its periphery, defining first and second walls, oriented so that bearing against them drives, respectively, pivoting of the hinged portion 26 in the clockwise and counterclockwise directions.

The mechanism also comprises a control organ 32 that can move between first and second positions defined by a power reserve mechanism and smaller than a predefined power reserve of the energy source. According to the proposed embodiment, the control organ 32 includes a cam driven by the barrel and the position of which is characteristic of the power reserve of the barrel. The cam is advantageously a finger 34 mounted on a wheel pivoting over less than 360° between maximum winding and maximum unwinding of the barrel.

The control organ also includes a lever 36 intended to cooperate, on the one hand, with the finger 34 and, on the other hand, with the hinged portion 26. The lever 36 is provided, on its periphery, with first 38 and second 40 housings, with which a jumper spring 42 works, thereby defining first and second positions that the lever 36 can occupy. The lever 36 is also provided with a catch defining first 44 and second 45 faces, with which the finger 34 cooperates. The finger 34 is positioned so as to cooperate with one or the other of the two faces 44 or 45 when the power reserve of the barrel reaches a predefined value, both during unwinding and winding thereof. Typically, the predefined value can be twenty-four hours of running for the going train if the movement includes a single barrel for the train and for the striking mechanism. A protruding element, such as a pin 46, is driven into the lever 36 and is positioned so as to cooperate with the hollow 28 of the hinged portion 26.

Thus, during operation, when the power reserve of the barrel is greater than the predefined value (see FIG. 1), the jumper spring 42 cooperates with the first housing 38 and keeps the barrel 36 in its first position. The pin 46 bears on the first wall of the hollow 28, which, combined with the guiding of the lever by the spring 22 and the bridge 20, positions the push-piece 12 in its first position. When the user of the watch exerts pressure on the push-piece 12, the finger 14 will cross the beak 16 and cause a striking mechanism to be released.

When the barrel is unwound, the finger 34 rotates counterclockwise relative to the figures. When the power reserve drops below the predefined value, the finger 34 pushes the face 44. The lever 36 pivots clockwise and, under the action of the jumper spring 42, it is thus brought into its second position. The pin 46 comes into contact with the second wall of the hollow 28 and pushes it. This pressure, combined with the guiding of the lever by the spring 22 and the bridge 20, moves the push-piece away from the beak 16 and brings it into its second position. When the user of the watch exerts pressure on the push-piece 12, the finger 14 will not cross the beak 16 and therefore will not cause a striking to be released.

When the barrel is wound, when the power reserve again becomes greater than the predefined value, the finger 34 is driven clockwise and pushes the face 45, thereby returning the lever and the push-piece to their first position.

Thus proposed is a striking mechanism provided with a safety making it possible to deactivate the striking mechanism when the power source only has a power reserve below a threshold value. The mechanism according to the invention is particularly simple and reliable by acting directly on the release organ.

Although the description above was done in reference to a striking mechanism, one skilled in the art may adapt the different functional elements of the safety to any additional mechanism that can be released by moving a release beak cooperating with a release organ. Particularly, the release beak can be a tooth of the ratchet of a column wheel of a chronograph mechanism, the release finger being moved by actuating a control push-piece without, however, going beyond the scope of the invention. The fact that the finger is mobile on the push-piece also offers, in such a case, excellent operating security.

1-7. (canceled)

8. A timepiece, comprising:
an energy source,
a control organ able to move between first and second positions defined by a power reserve mechanism,
an additional mechanism,
a release beak whereof the movement can cause the release of the striking mechanism, and
a release organ intended to receive pressure from a user of the timepiece to cooperate with said release beak to release the striking mechanism,
wherein the release organ can occupy a first position in which it can cooperate with the release beak and a second position in which it cannot cooperate with the release beak, and the control organ is arranged so as to cooperate with the release organ and to bring it into its first or second positions, depending on whether said control organ is in its first or second position.

9. The timepiece of claim 8, wherein the additional mechanism is a striking mechanism.

10. The timepiece of claim 8, wherein the control organ includes a lever and a cam driven by the barrel, said lever being able to occupy either a first or second position of the control organ.

11. The timepiece of claim 9, wherein the control organ includes a lever and a cam driven by the barrel, said lever being able to occupy either a first or second position of the control organ.

12. The timepiece of claim 10, wherein the cam is a finger mounted on a wheel indicating the power reserve of the energy source.

13. The timepiece of claim 11, wherein the cam is a finger mounted on a wheel indicating the power reserve of the energy source.

14. The timepiece of claim 10, wherein the lever includes a catch defining first and second faces with which the cam cooperates to make the lever go from one to the other of the first and second positions.

15. The timepiece of claim 11, wherein the lever includes a catch defining first and second faces with which the cam cooperates to make the lever go from one to the other of the first and second positions.

16. The timepiece according to claim 8, wherein the release organ includes a lever actuated by a push-piece, ending with a hinged portion intended to cooperate with the control organ.

17. The timepiece of claim 16, wherein said control organ also includes a finger movably mounted on the push-piece and intended to cooperate with said release beak.
